(19) United States
(12) Patent Application Publication
(10) Pub. No.: US 2009/0050325 A1
(43) Pub. Date: Feb. 26, 2009

(54) Enzyme enhanced oil recovery (EEOR) for near wellboretreatment of oil and gas with greater than 50% barrel of oil equivalent (BOE) gas production

(76) Inventors: John L. Gray, Houston, TX (US); Allan R. Hartman, Houston, TX (US)

Correspondence Address: GUERRY LEONARD GRUNE, 784 S VILLIER CT., VIRGINIA BEACH, VA, 23452, US

(21) Appl. No.: 11/894,923

(22) Filed: Aug. 22, 2007

(51) Int. Cl. E21B 43/22; C09K 8/035; E21B 43/24; E21B 37/06

(52) U.S. Cl. 166/304; 166/305.1; 507/201

(57) ABSTRACT

Disclosed is a system for injecting an enzymatic fluid composition into a gas or gas and oil near-well bore having a wide temperature range. The enzymatic fluid composition is a treatment for reducing oil deposits, asphaltenes, waxes, scale, or other hydrocarbon materials in a gas well or a combination gas/oil well where the production of gas is greater than 50% on a barrel of oil equivalent (BOE) basis.

### FIELD OF DISCLOSURE

A composition, method and system is provided for improving the effectiveness of near well bore clean up and production optimization of gas wells in a subterranean formation. The treatment is made more effective by first treating the well with an enzymatic fluid that quickly releases from the formation and solid surfaces residual oil, asphaltenes, waxes and other hydrocarbon materials that may be inhibiting gas flow.

### BACKGROUND OF DISCLOSURE

The trajectory of a near well bore is generally tortuous whether it is vertical or horizontal. The wall of the bore often has various ledges and cavities that will collect fluid that has come into contact with it. The fluid, such as well bore oil, asphaltenes, waxes and other hydrocarbon materials from the well, come in contact with and adhere to the well bore.

Most oilfield applications for enzymes today are in frac fluids. Hydraulic fracturing is accomplished by injecting a hydraulic fracturing fluid into the well and imposing sufficient pressure on the fracture fluid to cause formation breakdown with the attendant production of one or more fractures. Usually a gel, an emulsion or a foam, having a proppant, such as sand or other suspended particulate material, is introduced into the fracture. The proppant is deposited in the fracture and functions to hold the fracture open after the pressure is released and fracturing fluid is withdrawn back into the well. The fracturing fluid has a sufficiently high viscosity to penetrate into the formation and to retain the proppant in suspension or at least to reduce the tendency of the proppant of settling out of the fracturing fluid. Generally, a gelation agent and/or an emulsifier is used in the fracturing fluid to provide the high viscosity needed to achieve maximum benefits from the fracturing process.

After the high viscosity fracturing fluid has been pumped into the formation and the fracturing has been completed, it is, of course, desirable to remove the fluid from the formation to allow hydrocarbon production through the new fractures. The removal of the highly viscous fracturing fluid is achieved by “breaking” the gel or emulsion or by converting the fracturing fluid into a low viscosity fluid. The act of breaking a gelled or emulsified fracturing fluid has commonly been obtained by adding “breaker”, that is, a viscosity-reducing agent, to the remaining gelled fluid in the subterranean formation at the desired time. This technique can be unreliable sometimes resulting in incomplete breaking of the fluid and/or premature breaking of the fluid before the process is complete reducing the potential amount of hydrocarbon recovery. Further, it is known in the art that most fracturing fluids will “break” if given enough time and sufficient temperature and pressure.

Several proposed methods for the breaking of fracturing fluids are aimed at eliminating the above problems such as introducing an encapsulated percarbonate, perchlorate, or persulfate breaker into a subterranean formation being treated with the fracturing fluid. Various chemical agents such as oxidants, i.e., perchlorates, percarbonates and persulfates not only degrade the polymers of interest but also oxidize tubulars, equipment, etc. that they come into contact with, including the formation itself. In addition, oxidants also interact with resin-coated proppants and, at higher temperatures, they interact with gel stabilizers used to stabilize the fracturing fluids, which tend to be antioxidants. Also, the use of oxidants as breakers is disadvantageous from the point of view that the oxidants are not selective in degrading a particular polymer. In addition, chemical breakers are consumed stoichiometrically resulting in inconsistent gel breaking and some residual viscosity which causes formation damage.

The use of enzymes to break fracturing fluids may eliminate some of the problems relating to the use of oxidants. For example, enzyme breakers are very selective in degrading specific polymers. The enzymes do not effect the tubulars, equipment, etc. that they come in contact with and/or damage the formation itself. The enzymes also do not interact with the resin-coated proppants commonly used in fracturing systems. Enzymes react catalytically such that one molecule of enzyme may hydrolyze up to one hundred thousand (100,000) polymer chain bonds resulting in a cleaner more consistent break and very low residual viscosity. Consequently, formation damage is greatly decreased. Also, unlike oxidants, enzymes do not interact with gel stabilizers used to stabilize the fracturing fluids.

It has been discussed previously that there are several methods for enhancing the release of hydrocarbons from a well, however, there is no art disclosed where an enzyme has been used as a treatment for a gas well or as an alternative to acid treatments.

Therefore, there exists a need for a system for injecting an enzymatic fluid composition having a wide temperature range for activity and being active at temperatures for preheating up to and about 80 to 90 degrees Celsius liquid phase temperature with increased temperature stability under pressure. The disclosure of the present application provides for injecting an enzymatic fluid composition, that is not a breaker for the dissolution of polymeric viscosifiers, as a treatment for reducing oil deposits, ashphaltenes, waxes, scale, or other hydrocarbon materials in a gas well or a combination gas/oil well where the production of gas to oil is greater than 50% on a barrel of oil equivalent (BOE), by reducing surface tension and decreasing contact angle associated with the gas flow or other hydrocarbons.

### RELEVANT ART

U.S. Pat. No. 5,165,477, to Shell, et. al., and assigned to Phillips Petroleum Co. which describes a method of removing used drilling mud of the type comprising solid materials including at least one polymeric organic viscosifier from a well bore and portions of formations adjacent thereto comprising: injecting a well treatment fluid comprising an enzyme capable of rapidly enzymatically degrading said polymeric organic viscosifier into said well; and allowing said enzyme to degrade said polymeric organic viscosifier and said well treatment fluid to disperse said used drilling mud. In this invention, Shell adds the enzyme to a viscosifier.

U.S. Pat. No. 5,881,813, to Brannon, et. al., and assigned to Phillips Petroleum Co. which describes a method for improving the effectiveness of a well treatment in subterranean formations comprising the steps of: injecting a clean-up fluid into the well wherein the clean-up fluid contains one or more enzymes in an amount sufficient to degrade polymeric viscosifiers; contacting the well bore and formation with the clean-up fluid for a period of time sufficient to degrade polymeric viscosifiers therein; performing a treatment to remove non-polymer solids that may be present; and removing the non-polymer solids in the well to improve productivity or injectivity of the subterranean formation.

U.S. Pat. No. 5,566,759, to Tjon-Joe-Pin, et. al., and assigned to BJ Services, describes a method of reducing the viscosity of a cellulose-containing fluid used during workover, fracturing or completion operations and found within a subterranean formation which surrounds a completed well bore comprising the steps of formulating the cellulose-containing fluid by blending together an aqueous fluid, a cellulose-containing hydratable polymer, and an enzyme system. The cellulose-containing fluid is pumped to a desired location within the well bore allowing the enzyme treatment to degrade the polymer, whereby the fluid can be removed from the subterranean formation to the well surface and wherein the enzyme treatment has activity in the pH range of about 9 to about 11 and effectively attacks β-D-gluocosidic linkages in the hydratable polymer.

U.S. Pat. No. 5,247,995, to Tjon-Joe-Pin, et. al., and assigned to BJ Services, which describes a method of increasing the flow of production fluids from a subterranean formation by removing a polysaccharide-containing filter cake formed during production operations and found within the subterranean formation which surrounds a completed well bore comprising the steps of allowing production fluids to flow from the well bore, reducing the flow of production fluids from the formation below expected flow rates and formulating an enzyme treatment by blending together an aqueous fluid and enzymes. The enzyme treatment is pumped to a desired location within the well bore and the enzyme treatment is allowed to degrade the polysaccharide-containing filter cake, whereby the filter cake can be removed from the subterranean formation to the well surface.

U.S. Pat. No. 6,818,594, to Freeman, et. al., and assigned to M.I.L.L.C., which describes a method of degrading a predetermined substrate used for hydrocarbon exploitation comprising providing a fluid or a solid, or a mixture thereof, containing a substrate-degrading agent inactivated by encapsulation. The inactivated substrate-degrading agent is initially substantially inactive and subsequently becomes active in response to a predetermined triggering signal. The triggering signal to the fluid or solid or mixture thereof is applied such that the substrate-degrading agent becomes activated, the activated substrate-degrading agent is capable of at least partially degrading the substrate, said triggering signal selected from the group consisting of exposure to a reducing agent, oxidizer, chelating agent, radical initiator, carbonic acid, ozone, chlorine, bromine, peroxide, electric current, ultrasound, change in pH, change in salinity, change in ion concentration, reversal of well bore pressure-differential, and combinations thereof.

U.S. Pat. No. 6,138,760, to Lopez, et. al., and assigned to BJ Services, describes a method for treating a subterranean formation comprising introducing a pre-treatment fluid into the subterranean formation. The pre-treatment fluid comprises at least one breaker, then introducing a polymer-containing treatment fluid comprising at least one polymer into the subterranean formation. The fluid is then removed from the subterranean formation wherein the breaker contacts the polymer as fluid is removed from the subterranean formation and the breaker is effective to degrade and remove the polymer as the fluid is removed from the subterranean formation.

U.S. Pat. No. 6,110,875, to Tjon-Joe-Pin, et. al., and assigned to BJ Services, describes a method for degrading xanthan molecules comprising the step of contacting the molecules with xanthanase enzyme complex produced by a soil bacterium bearing the ATCC No. 55941 under conditions such that at least a portion of the molecules are degraded.

U.S. Pat. No. 6,936,454, to Kelly, et. al., and assigned to North Carolina State University, which describes a composition comprising an isolated mannanase enzyme that hydrolyzes β-1,4 hemicellulolytic linkages in galactomannans at a temperature above 180° F. and that is essentially incapable of degrading the linkages at a temperature of 100° F. or less.

U.S. Pat. No. 6,428,995, to Kelly, et. al., and assigned to North Carolina State University, which describes a composition comprising an isolated α-galactosidase enzyme that hydrolyzes α-1,6 hemicellulolytic linkages in galactomannans at a temperature above 180° F. and that is essentially incapable of degrading said linkages at a temperature of 100° F. or less.

U.S. Pat. No. 6,197,730, to Kelly, et. al., and assigned to North Carolina State University, which describes a hydraulic fracturing fluid useful for fracturing a subterranean formation that surrounds a well bore comprising an aqueous liquid, a polysaccharide soluble or dispersible in the aqueous liquid in an amount sufficient to increase the viscosity of the aqueous liquid and an enzyme breaker that degrades the polysaccharide at a temperature above 180° F. It is essentially incapable of degrading the polysaccharide at a temperature of 100° F. or less, wherein the enzyme breaker comprises a mannanase that degrades the polysaccharide and the enzyme breaker included in an amount effective to degrade the polysaccharide at the temperature.

U.S. Pat. No. 5,869,435, to Kelly, et. al., and assigned to North Carolina State University, which describes a hydraulic fracturing fluid useful for fracturing a subterranean formation which surrounds a well bore comprising an aqueous liquid, a polysaccharide soluble or dispersible in the aqueous liquid in an amount sufficient to increase the viscosity of the aqueous liquid and an enzyme breaker which degrades the polysaccharide at a temperature above 195° F. and which is essentially incapable of degrading said polysaccharide at a temperature of 100° F. or less. The enzyme breaker comprises a mannanase which hydrolyzes β-1,4 hemicellulolytic linkages in galactomannans and an α-galactosidase which hydrolyzes α-1,6 hemicellulolytic linkages. In galactomannans, the enzyme breaker is included in an amount effective to degrade the polysaccharide at the temperature.

U.S. Pat. No. 5,421,412, to Kelly, et. al., and assigned to North Carolina State University, which describes a method of fracturing a subterranean formation which surrounds a well bore providing a fracturing fluid comprising, an aqueous liquid, a polysaccharide soluble or dispersible in the aqueous liquid in an amount sufficient to increase the viscosity of the aqueous liquid, and an enzyme breaker which degrades the polysaccharide at a temperature above 180° F. The enzyme breaker comprises a mannanase which degrades the polysaccharide at a temperature above 180° F. then injecting the fracturing fluid into the well bore at a pressure sufficient to form fractures in the subterranean formation which surrounds the well bore and then releasing the pressure from the fracturing fluid.

U.S. Pat. No. 4,506,734, to Nolte, Kenneth G., and assigned to The Standard Oil Company, describes a method for reducing the viscosity of a fluid introduced into a subterranean formation comprising introducing, under pressure, a viscosity reducing chemical contained within hollow or porous, crushable beads, and the fluid into the formation and reducing the introduction pressure so any resulting fractures in the formation close and crush the beads whereby the crushing of the beads releases the viscosity reducing chemical.

U.S. Pat. No. 6,672,388, to McGregor, et. al., and assigned to Lamberti, USA, Inc., which describes a process for cleaning a well bore wall, tubing or casing using a turbulent flow regime characterized by: preparing an aqueous surfactant composition containing from about 10% to 60% by weight of a mixture of surfactants. The mixture comprises from 10% to 50% by weight of an anionic derivative of an alkylpolyglycoside, from 35% to 80% by weight of an alkylpolyglycoside and from 5% to 25% by weight of an anionic derivative of a fatty alcohol with their balance being 100%. The aqueous surfactant composition is diluted in water and injected into a well bore containing drilling mud, oily residues or other undesirable deposits. Extracted from the well bore are the diluted aqueous surfactant composition and drilling mud, oily residues or other undesirable deposits.

U.S. Pat. No. 5,400,430, to Nenninger, John E., and unassigned, which describes a method of stimulating an injection well having a well bore comprising, placing a heater within the well bore, at or near the bottom of the well bore, adjacent to the area to be treated. A source of power is provided to the heater to energize the heater and a solvent is flowed past the energized heater to heat the solvent to contact solid wax deposits located in the treatment area to mobilize the wax and to form an oil/solvent/wax phase. The solvent and the mobilized wax from the treatment area are removed thereby removing solid wax deposits from the treatment area followed by injecting waterflood water into the injection well.

U.S. Pat. No. 5,126,051, to Shell, et. al., and assigned to Phillips Petroleum Co., describes a method of cleaning up a well site drilling mud pit comprising solid materials including at least one polymeric organic viscosifier and water comprising, admixing an enzyme capable of enzymatically degrading the polymeric organic viscosifier with the drilling mud to degrade the polymeric organic viscosifier and allowing settleable solid materials remaining in the drilling mud to settle in the mud pit from the water.

U.S. Patent Publication # 2006/0096758A1, to Berry, et. al., and assigned to BJ Services, which describes a method of treating an oil or gas well having a well bore which comprises introducing into the well bore a well treating agent comprising a C1-C4 ester of a C16-C20 fatty acid.

U.S. Patent Publication # 2006/0096757A1, to Berry, et. al., and assigned to BJ Services, which describes a method of treating an oil or gas well having a well bore which comprises introducing into the well bore a blend comprising C1-C4 ester of lactic acid and C1-C4 ester of a C16-C20 fatty acid.

### SUMMARY OF THE DISCLOSURE

An embodiment of the disclosure is a method of near well bore treatment for releasing deposits for gas wells or other associated production whether oil or other hydrocarbon production; a treating fluid and one or more enzyme, such as Greenzyme®, wherein the enzyme is oleophilic and the treating fluid is injected into the near well bore of a reservoir formation wherein the treating fluid contacts the hydrocarbon deposits inhibiting the flow of oil to the well bore with the hydrocarbon deposits being released by the enzyme wherein the surface attraction is reduced between the hydrocarbon deposits and the reservoir formation releasing the hydrocarbons deposits to improve flow and be less restricted from passages back to the well bore of the producing well and recovered by pumping or other means from the well.

Another embodiment of this disclosure is an enzymatic fluid that is injected near-well bore that releases and helps prevent the build up of oils, waxes, asphaltenes and other hydrocarbon particulates thereby increasing the flow of gas, oil, distillates and/or condensate gas.

Another embodiment is an injected enzymatic fluid that is injected near-well bore for a gas well or a combination gas/oil well wherein the gas production is >50% on barrel of oil equivalent (BOE) basis.

Another embodiment is an injected enzymatic fluid that reduces the surface tension of a well bore thereby improving the mobility and flow to the well bore and may be used to get better displacement of gas or oil within the well.

Another embodiment is an injected enzymatic fluid that may be injected at ambient temperatures or preheated prior to injection near-well bore.

Another embodiment is an injected enzymatic fluid wherein the enzyme composition is Greenzyme®.

Another embodiment is an injected enzymatic fluid wherein the enzyme composition targets hydrocarbon particulates that are produced with the gas that can block or restrict flow by reducing surface tension. The injected enzymatic fluid does not target thickened gels, filter cakes or cross-linked polymers associated with drilling and completing wells.

Another embodiment is an injected enzymatic fluid that does not change the chemical composition of the crude oil and is non-reactive with gas, but may free dissolved gas from oil.

Another embodiment is an injected enzymatic fluid that does not directly reduce the hydrocarbon viscosity, but has the “indirect” effect of increasing flow of gas by reducing surface tension, decreasing contact angles of associated oil, distillate or gas condensate and preventing oil or hydrocarbon components from re-adhering to the near-well bore area.

Another embodiment is an injected enzymatic fluid that does not alter oil chemistry.

Another embodiment is an injected enzymatic fluid that provides a stand-alone treatment as an alternative to traditional hydrochloric or other acid treatments.

Another embodiment is an injected enzymatic fluid that is not restricted in its use with gas wells by the API gravity of associated oil or other hydrocarbons produced.

Another embodiment is an injected enzymatic fluid that may be used in vertical or horizontal wells for most formations and near well bore permeabilities.

Another embodiment is an injected enzymatic fluid that has a tolerance for deeper gas wells that have temperatures up to 270° C. under pressure.

Another embodiment is an injected enzymatic fluid that may be allowed to “soak” prior to returning the well to production.

Another embodiment is an injected enzymatic fluid that is lower risk than acid injection and is safe for the environment.

Another embodiment is an injected enzymatic fluid that is typically injected at between 3%-10% enzyme concentration.

Another embodiment is an injected enzymatic fluid that is injected at a pressure lower than the near-well bore fracture pressure.

### BRIEF DESCRIPTION OF THE DRAWINGS

FIG. 1 is a description of the method of using an enzyme composition to release hydrocarbon deposits from a near-well bore of a gas well.

### DETAILED DESCRIPTION OF THE DRAWINGS

Disclosed is an improvement to near well bore treatments of gas wells for secondary and/or tertiary recovery of gas and other hydrocarbons that utilizes an enzyme composition. In particular the utilizing of an enzyme fluid like GREENZYME®, trademarked by Apollo Separation Technologies, Inc. of Houston, Tex. GREENZYME® is a biological enzyme that is a protein based, non-living catalyst for penetrating and releasing oils, waxes, asphaltenes and other hydrocarbon particulates from solid surfaces and demonstrates the following attributes:

GREENZYME® has the effect of increasing the mobility of the oil by reducing surface tension, decreasing contact angles and preventing hydrocarbons from re-adhering to the near well bore area in a formation.

GREENZYME® is active in water and acts catalytically in contacting and releasing oils, waxes, aspartames and other hydrocarbon particulates from solid surfaces.

GREENZYME® is effective up to 270 degrees Celsius in liquid phase under pressure and is not restricted by variations in the American Petroleum Institute (API) specific gravity ratings of the crude oil.

GREENZYME® is not an oil viscosity modifier nor does it change the chemical composition of the oil.

GREENZYME® is not a live microbe and does not require nutrients or ingest oil.

GREENZYME® does not grow or plug an oil formation.

GREENZYME® does not trigger any other down whole mechanisms, except to release oil from the solid substrates. (I.e.: one function).

Other suitable enzymes other than GREENZYME® are also the subject of the present disclosure and can be used interchangeably or separately from GREENZYME® to meet the EEOR requirements of individual wells.

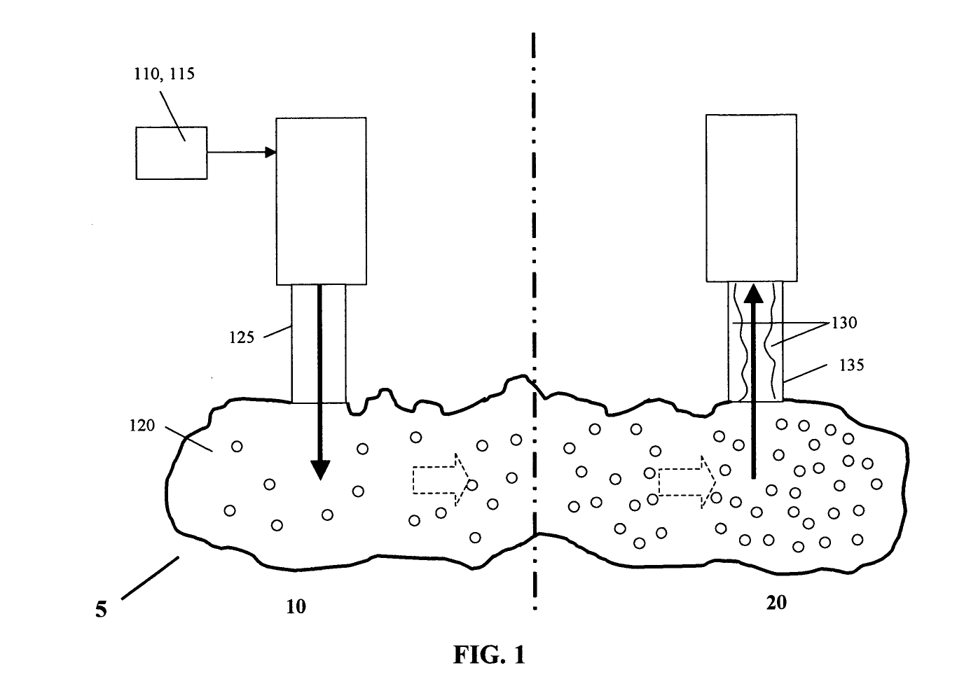

Referring to FIG. 1, in an overview, the injected enzymatic fluid system [5] is comprised of two (2) stages. The first stage is treatment [10] followed by a production stage [20] to produce gas and other hydrocarbons. Optionally there may be an idle period known as a soak stage (not shown) prior to returning the well to the production of gas and other hydrocarbons. This injected enzymatic fluid system [5] may be repeated whenever recovery volumes diminish to a calculated economic break-even point.

In the stage of treatment [10], an enzyme composition such as GREENZYME® [110], and described above, is diluted to in a range of 3% to 10% to become a diluted enzymatic fluid [115]. This diluted enzymatic fluid [115] is injected into a gas well [120] or combination gas/oil well where the production of gas is >50% on a BOE basis. The diluted enzymatic fluid [115] may be heated to 80° C.-90° C. prior to injection. A sufficient volume of the diluted enzymatic fluid [115] is then pumped through an injection pipe [125] and into the gas well [120] so as to contact an amount of residual oils, waxes, asphaltenes and other hydrocarbon particulates [130] that may be restricting the production well bore [135]. Injection pipe [125] and production well bore [135] may be the same pipe in a single well bore configuration. The diluted enzymatic fluid [115] acts to release the dissolved gas and oil from solid surfaces, increase the mobility of the oil by reducing surface tension, decreasing contact angles, preventing oils, waxes, asphaltenes and other hydrocarbon particulates [130] from re-adhering to the production well bore [135] as it cools and acts catalytically releasing hydrocarbon particulates [130] from solid surfaces. Blockages in the gas well [120] may be reduced or eliminated as well.

Additionally, there may be a pre-treatment or soak period to allow the diluted enzymatic fluid [115] penetrate the oils, waxes, asphaltenes and other hydrocarbon particulates further. The diluted enzymatic fluid [115] remains active in solution and acts catalytically in contacting and releasing oils, waxes, asphaltenes and other hydrocarbon particulates from solid surfaces. It is not restricted by most ranges in the American Petroleum Institute (API) specific gravity ratings for crude oil. The soak stage lasts between 0-30 days depending on the type and size of the gas well [120].

Following the soak stage [30], the hydrocarbon particulates [130] are removed from the production well bore [135] thereby reducing the hydrocarbon particulates [130] restrictions and increasing the production well bore [135] volume. The increased production well bore [135] volume permits gas to flow with less pressure required to move the gas to surface.

We claim:

1. A method of near-well bore treatment for releasing hydrocarbon deposits for wells comprising; one or more enzyme treating fluids, wherein said enzyme fluid is oleophilic and said treating fluid is injected into said near-well bore of a reservoir wherein said treating fluid contacts restricting hydrocarbon particulates inhibiting the flow of gas and oil to said near-well bore; wherein surface attraction between said hydrocarbon particulates and said wellbore is reduced and said hydrocarbon particulates are subsequently or simultaneously released by said enzyme fluid such that flow restriction of said gas and said oil in the near well bore area is minimized.

2. The method of near-well bore treatment as in claim 1, wherein said enzyme fluid injected in an area within said near-well bore releases the build up of oils, waxes, asphaltenes and other hydrocarbon particulates thereby increasing the flow of said gas, said oil, distillates or condensate gas.

3. The method of near-well bore treatment as in claim 1, wherein said enzyme fluid is injected into an area within said near-well bore for a gas well or a gas well with oil production wherein said gas produced is greater than 50 percent a barrel of oil equivalent (BOE).

4. The method of near-well bore treatment as in claim 1, wherein said enzyme fluid reduces the surface tension of said near-well bore thereby improving the mobility and flow to said near-well bore and wherein said reduction of surface tension better displaces said gas or said oil within said well.

5. The method of near-well bore treatment as in claim 1, wherein said enzyme fluid may be preheated prior to injection.

6. The method of near-well bore treatment as in claim 1, wherein said enzyme fluid comprises a biological enzyme that is a protein based, non-living catalyst.

7. The method of near-well bore treatment as in claim 1, wherein said enzyme treating fluid and said enzyme targets said hydrocarbon particulates such that said hydrocarbon particulates further aid in reduction of surface tension of said near-well bore surface(s) further increasing production of said gas or said oil.

8. The method of near-well bore treatment as in claim 1, wherein said enzyme fluid is inert and does not specifically target fracturing fluids associated with fracturing, drilling or completing said well.

9. The method of near-well bore treatment as in claim 1, wherein said enzyme does not change the chemical composition of said gas or said oil and is non-reactive with said gas freeing dissolved said gas from said oil.

10. The method of near-well bore treatment as in claim 1, wherein said enzyme fluid reduces said hydrocarbon particulates viscosity, thereby increasing flow of said gas by reducing surface tension, decreasing contact angles with said oil distillate, or gas as a condensate and preventing said oil or said hydrocarbon particulates from re-adhering to said near-well bore.

11. The method of near-well bore treatment as in claim 1, wherein said enzyme fluid provides a stand-alone treatment in lieu of traditional hydrochloric or other acid treatments.

12. The method of near-well bore treatment as in claim 1, wherein said enzyme fluid can be used together with the range of API gravity oils or with hydrocarbon deposits produced during production of said well.

13. The method of near-well bore treatment as in claim 1, wherein said enzyme fluid may be used in said wells in a vertical or horizontal direction with most formations and permeabilities.

14. The method of near-well bore treatment as in claim 1, wherein said enzyme fluid is used in said wells having temperatures up to 270° C. under pressure.

15. The method of near-well bore treatment as in claim 1, wherein said enzyme fluid is allowed to soak in said well allowing said well once again producing said gas and other hydrocarbons from said well.

16. The method of near-well bore treatment as in claim 1, wherein said enzyme fluid is environmentally benign in comparison with acid injection treatment.

17. The method of near-well bore treatment as in claim 1, wherein said enzyme fluid comprises said enzyme in a concentration of between 0.5 and 10 percent.

18. The method of near-well bore treatment as in claim 1, wherein said enzyme fluid injection pressure is lower than the fracture pressure of said near-well bore.
